(19) United States
(12) Patent Application Publication
(10) Pub. No.: US 2010/0068643 A1
(43) Pub. Date: Mar. 18, 2010

(54) ELECTROSTATIC-IMAGE-DEVELOPING TONER, PROCESS FOR PRODUCING ELECTROSTATIC-IMAGE-DEVELOPING TONER, ELECTROSTATIC IMAGE DEVELOPER, AND IMAGE-FORMING APPARATUS

(75) Inventors: Eisuke IWAZAKI, Kanagawa (JP); Shuji SATO, Kanagawa (JP); Atsushi SUGAWARA, Kanagawa (JP); Hiroshi NAKAZAWA, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/405,760

(22) Filed: Mar. 17, 2009

(30) Foreign Application Priority Data
Sep. 17, 2008 (JP) 2008-238084

(51) Int. Cl. G03G 9/087; G03G 9/08; G03G 9/113; G03G 9/09; G03G 15/06

(52) U.S. Cl. 430/108.21; 399/222

(57) ABSTRACT

An electrostatic-image-developing toner includes a binder resin; a colorant; a releasing agent having a melting temperature of from about 70° C. to about 100° C.; and an ethylenediaminedisuccinic acid.

### CROSS-REFERENCE TO RELATED APPLICATIONS

This application is based on and claims priority under 35 USC 119 from Japanese Patent Application No. 2008-238084 filed on Sep. 17, 2008.

### BACKGROUND

1. Technical Field

The present invention relates to an electrostatic-image-developing toner, a process for producing an electrostatic-image-developing toner, an electrostatic image developer, and an image-forming apparatus.

2. Related Art

Methods of visualizing image information via electrostatic latent images in the electrophotographic and other methods have been used in various applications. In the electrophotographic method, visualization is conducted by forming an electrostatic latent image on an image-holding member in a charging step and an exposing step (a latent image-forming step), developing the electrostatic latent image with an electrostatic image developer (hereinafter, in some cases, referred to merely as “developer”) containing an electrostatic image-developing toner (hereinafter, in some cases, referred to merely as “toner”) (a developing step), and subjecting to a transfer step and a fixing step. As the developer to be used here, there are known a two-component developer comprising a toner and a carrier and a one-component developer independently using a magnetic toner or a non-magnetic toner.

As a process for producing the toner, a kneading and pulverizing method of melt-kneading a binder resin such as a thermoplastic resin with a colorant such as a pigment, a charge controlling agent, and a releasing agent such as a wax and, after cooling, pulverizing, and classifying is commonly utilized. In some cases, inorganic or organic particles for improving flowing properties and cleaning properties are added to the surface of the toner particles. Such process can produce a fairly excellent toner. However, the resulting toner has an amorphous shape, fine powder is liable to be generated, and the releasing agent is easily laid bare on the surface of the toner particles, thus such a toner possibly causing the problem of deterioration of developing properties and image quality due to stress received inside the developing device and the problem of staining of other members.

In recent years, as a technique which enables one to intentionally control the shape and the surface structure of a toner, there have been proposed a process for producing a toner according to a wet production process such as an emulsion polymerization aggregating process. The emulsion polymerization aggregating process is generally a production process including preparing a resin particle dispersion by emulsion polymerization or the like, mixing the resin particle dispersion with a colorant dispersion prepared by dispersing the colorant in a solvent to form aggregated particles having a particle diameter corresponding to the toner particle diameter, and heating the mixture to fuse and coalesce into a toner. This process enables one to control the toner shape to some extent and improve charging properties and durability but, since the toner has approximately a uniform inner structure, there might result deteriorated melting-out ability of the releasing agent component, possibly leading to reduction of fixed image gloss and occurrence of gloss unevenness.

### SUMMARY

According to an aspect of the invention, there is provided an electrostatic-image-developing toner including: a binder resin; a colorant; a releasing agent having a melting temperature of from about 70° C. to about 100° C.; and an ethylenediaminedisuccinic acid.

### BRIEF DESCRIPTION OF THE DRAWINGS

Exemplary embodiment(s) of the present invention will be described in detail based on the following figures, wherein:

FIG. 1 is a schematic view showing one example of an image-forming apparatus in accordance with the exemplary embodiment of the invention; and

FIG. 2 is a schematic view showing other example of an image-forming apparatus in accordance with the exemplary embodiment of the invention,

wherein

1 and 3 denote an image-forming apparatus, 10 denotes a charging station, 11 denotes a charging roll, 12 denotes an exposing station, 14 denotes an electrophotographic photoreceptor, 16 denotes a developing station, 18 denotes a transfer station, 20 denotes a cleaning station, 22 denotes a fixing station, 24 denotes a transfer-receiving material, 50 denotes a cleaning roll, 56 denotes a cleaning blade, 58 denotes an exposing device, 62 denotes a recording paper, 64Y, 64M, 64C and 64K denote an image-forming unit, 66Y, 66M, 66C and 66K denote a developing device, 68 denotes a paper-conveying belt, 70 denotes a fixing device, 72 denotes a discharge roll, 74 denotes a discharge tray, 76 denotes a paper-conveying path, and 78 denotes a conveying roll.

### DETAILED DESCRIPTION

An exemplary embodiment of the present invention will be described below. This exemplary embodiment is a mere example and does not limit the present invention in any way.

<Electrostatic-Image-Developing Toner>

The toner in accordance with this exemplary embodiment includes a binder resin, a colorant, a releasing agent having a melting temperature of from about 70° C. to about 100° C., and ethylenediaminedisuccinic acid.

In order to obtain a fixed image with less gloss unevenness, it is preferred for the releasing agent to ooze out to the surface of the fixed image as uniformly as possible and to be molten as uniformly as possible. However, use of a releasing agent having a melting temperature of from 70° C. to 100° C. and a toner produced by, for example, an emulsion polymerization aggregating process causes in some cases gloss unevenness. In particular, in fixing at a low temperature (for example, 120° C. or lower than that), gloss unevenness is liable to occur. This may be attributed to that, upon fixing at a low temperature, moisture in the toner becomes water vapor and the water vapor plasticizes the releasing agent, thus crystallinity of the releasing agent being reduced so much that the releasing agent oozes out non-uniformly onto the surface of the fixed image, which is recognized as gloss unevenness.

The inventors have found that a fixed image having excellent surface gloss and less gloss unevenness can be obtained with maintaining excellent releasing properties in oil-less fixing by incorporating a releasing agent having a melting temperature of from about 70° C. to about 100° C. and ethylenediaminedisuccinic acid.

In the wet production process such as the emulsion polymerization aggregating process, the presence of moisture in the toner may be attributed to that a metal ion used as an aggregating agent remaining in the toner is liable to reacts with water during production of the toner to produce a hydroxide, thus moisture being liable to be introduced into the toner. In particular, in the case of using aluminum ion as an aggregating agent, it is considered that the aluminum ion is liable to produce an hydroxide of aluminum and, even after drying the toner, the toner still contains moisture, and this moisture plasticizes the releasing agent upon fixing of the toner to thereby reduce crystallinity of the releasing agent and generate gloss unevenness due to reduction of precipitation of the releasing agent onto the surface of the fixed image.

Thus, regarding toners produced by the wet production process such as the emulsion polymerization aggregating process (emulsion aggregation process), it is considered that, when the amount of a metal ion in the toner is reduced, production of hydroxide of the metal ion can be suppressed, thus the amount of moisture in the toner being reduced. As a result, generation of water vapor upon fixing a toner can be suppressed, and crystallinity of the releasing agent can be maintained, whereby uneven oozing of the releasing agent onto the surface of a fixed image can be suppressed, thus a fixed image having high gloss with no gloss unevenness being obtained.

The toner in accordance with this exemplary embodiment includes a releasing agent having a melting temperature of from about 70° C. to about 100° C. In case when the melting temperature of the releasing agent is lower than 70° C., the viscosity of the releasing agent upon fixing the toner is so seriously decreased due to the too low melting temperature of the releasing agent that the releasing agent becomes liable to adhere to a fixing roll, thus gloss unevenness being liable to occur. In case when the melting temperature of the releasing agent exceeds 100° C., the releasing agent does not melt upon fixing at a low temperature to cause releasing failure, thus gloss unevenness being liable to occur. The melting temperature of the releasing agent is preferably from about 85° C. to about 90° C.

The toner in accordance with this exemplary embodiment includes ethylenediaminedicuccinic acid. Ethylenediaminedicuccinic acid has four carboxyl groups and two amino groups. Ethylenediaminedicuccinic acid can remove excess metal ion from the toner aggregates in the aggregating step or the like by coordinating to the metal ion through the four carboxyl groups and the two amino groups to thereby form a complex, thus being able to reduce the amount of the metal ion in the toner. It is considered that, by reduction of excess metal ion in the toner, the hydroxide is scarcely produced and, therefore, generation of water vapor due to the hydroxide is suppressed, and the releasing agent is scarcely plasticized, which serves to precipitate the releasing agent as uniformly as possible, thus an image having high gloss with less gloss unevenness being obtained.

In the toner in accordance with this exemplary embodiment, the content of ethylenediaminedicuccinic acid is preferably from about 0.001% by weight to about 1.5% by weight, more preferably from about 0.005% by weight to about 0.5% by weight, based on the weight of entire toner. In case when the content is less than 0.001% by weight, the metal ion-removing effect is reduced in some cases whereas, in case when the content exceeds 1.5% by weight, ethylenediaminedicuccinic acid in some cases adheres not to the metal ion but to the releasing agent and reduces uniform oozing of the releasing agent upon fixing to thereby generate gloss unevenness.

Ethylenediaminedicuccinic acid contained in the toner in accordance with the exemplary embodiment can be confirmed and determined by, for example, HPLC analysis or NMR spectrometry.

In the high-pressure liquid chromatography (HPLC), an analyzing device (LC-08; manufactured by Japan Analytical Industry Co., Ltd.; column: INERTSIL ODS3 (94.6×250 mm), a detector (differential refractometer), and an ultraviolet ray absorption detector (254 nm) are used. Regarding measuring conditions, a 0.1% phosphoric acid aqueous solution is used as an eluent at a flow rate of 1.0 mL/min and, as a measuring sample, a sample prepared by dissolving 1 g of a toner in 10 mL of chloroform and removing insolubles is used.

In the NMR spectrometry, a ¹H-NMR device (JNM-AL400; manufactured by JEOL Ltd.) is used. Regarding measuring conditions, measurement is conducted at a measuring temperature of 25° C. using a 5-mm glass tube and a 3% by weight heavy water solution. As a measuring sample, a sample prepared by removing a carrier from the developer, dissolving the resulting toner in an organic solvent, and removing the binder resin through filtration or the like is used.

<Production Process for Producing an Electrostatic-Image-Developing Toner>

The production process in accordance with the exemplary embodiment for producing the electrostatic-image-developing toner is not particularly limited, with an emulsion polymerization aggregating process being preferred. The process for producing the electrostatic-image-developing toner in accordance with the exemplary embodiment preferably includes an aggregating step of mixing a resin particle dispersion containing the resin particles dispersed therein, a colorant dispersion containing the colorant dispersed therein, and a releasing agent dispersion containing the releasing agent having a melting temperature of from about 70° C. to about 100° C. dispersed therein to form aggregated particles to form aggregated particles; an adding step of adding ethylenediaminedisuccinic acid to the aggregation system; a stopping step of stopping growth of aggregation of the aggregated particles by adjusting pH within the aggregation system; and a fusing step of heating the aggregated particles to a temperature equal to, or higher than, the glass transition temperature of the resin particles to fuse the aggregated particles. The production process may include a washing step wherein the toner particles obtained by fusing are washed with water or the like, and a drying step of drying the washed toner particles. Also, the production process may include, as needed, after the aggregating step, a shell layer-forming step wherein the same or different kind of resin particles are added to adhere onto the surface of the aggregated particles.

Ethylenediaminedisuccinic acid may be added after or before stopping growth of the aggregated particles by adjusting the pH within the system to, for example, 5 to 10, after the aggregating step. Of these procedures, it is preferred to add, as in the latter procedure, ethylenediaminedisuccinic acid to the aggregation system after the aggregating step to thereby capture the metal ion within the aggregated particles and then stop growth of the aggregated particles by adjusting the pH within the system to, for example, 5 to 10. According to this procedure, the metal ion can be removed as uniformly as possible, thus the added ethylenediaminedisuccinic acid exhibiting more effects.

[Aggregating Step]

In the aggregating step, a resin particle dispersion, a colorant dispersion, and a releasing agent dispersion are first prepared.

The resin particles at least have a volume-average diameter of 1 μm or less, and can be prepared by a process such as emulsion polymerization. For example, emulsion polymerization is a process wherein one or plural kinds of polymerizable monomers scarcely soluble in a solvent having a comparatively high polarity such as water are added to the solvent together with a dispersing aid such as a surfactant to thereby form micelles within the dispersing medium, polymerization is initiated by adding thereto a water-soluble polymerization initiator to prepare resin particles. In this occasion, of the polymerizable monomers in the micelles, monomers having more hydrophilicity or higher polarity localize on the surface of the micelles, in other words, at the surface in contact with the solvent, thus presumably stabilizing the inside of the micelles. The polymerization is initiated by a polymerization initiator and, in the initiation of polymerization, polymerization tends to be initiated from a polymerizable monomer having a lower polarity. This may be attributed to that, with a polymerizable monomer having a higher polarity, H electrons within the polymerizable monomer are attracted due to the electron-attracting properties of the polar group, thus polymerizing properties of the monomer being reduced.

In the above-described aggregating step, individual particles in the mutually mixed resin particle dispersion the colorant dispersion, and the releasing agent dispersion are aggregated to form aggregated particles. The aggregated particles are formed by, for example, hetero aggregation. Also, for the purpose of stabilizing the aggregated particles and controlling particle size and particle size distribution, an ionic surfactant having a polarity different from that of the aggregated particles or a compound having at least a monovalent charge such as a metal salt may be added.

Also, the process may be conducted by mixing the materials at one time to cause aggregation or may be conducted in the following manner. That is, in the aggregating step, while the initial ionic balance of the ionic dispersants of different polarities has previously been deviated, it is ionically neutralized by adding the ionic surfactant or a compound having at least a monovalent charge such as a metal salt, and then mother aggregated particles of the first step is formed at a temperature lower than the glass transition temperature and, after the dispersion is stabilized, as the second step, a particle dispersion having been treated with an ionic dispersant of a polarity and an amount that compensates the deviation of the ionic balance is added thereto and, as needed, the dispersion is heated to a temperature lower than the glass transition temperature of the resin contained in the mother particles or additionally added particles to thereby stabilize at a higher temperature, and then the dispersion is heated to a temperature higher than the glass transition temperature to thereby coalesce the mother aggregated particles having on the surface thereof the particles added in the second step of causing aggregation. Further, this stepwise procedures for aggregation may be repeatedly performed plural times.

In the case of using a polyester resin as a binder resin in the exemplary embodiment, it is also possible to prepare the resin particle dispersion by first preparing the polyester resin and then dispersing it together with a dispersion stabilizer under the condition of high temperature and high pressure. In this case, too, incorporation of a polar group in the polyester resin serves to provide a resin exhibiting the effect of the exemplary embodiment since the polar group migrates to the vicinity of the surface.

As a dispersing medium to be used in the exemplary embodiment for the resin particle dispersion, the colorant dispersion, the releasing agent dispersion, and dispersions for other components, there are illustrated, for example, aqueous media.

Examples of the aqueous media include water such as distilled water and deionized water, and alcohols. These may be used independently or in combination of two or more thereof.

Also, as a production process for producing an electrostatic-image-developing toner to be used in the exemplary embodiment, a suspension polymerization process is also preferably used. This suspension polymerization process is a process wherein colorant particles, releasing agent particles, and the like are suspended in an aqueous medium to which a polymerizable monomer and, as needed, a dispersion stabilizer have been added and, after dispersing them till they are dispersed to desired particle size and particle size distribution, the polymerizable monomer is polymerized by, for example, heating, the resulting polymer is then separated from the aqueous medium and, as needed, washed and dried to form toner particles.

Specific examples of the polymerizable monomer include styrenes such as styrene, p-chlorostyrene, and α-methylstyrene; vinyl group-having esters such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate; vinylniriles such as acrylonitrile and methacrylonitrile; vinylethers such as vinyl methyl ether and vinyl isobutyl ether; vinyl ketones such as vinyl methyl ketone, vinyl ethyl ketone, and vinyl isopropenylketone; olefins such as ethylene, propylene, butadiene, and isoprene. A polymer or copolymer may be obtained by using one, two or more of these monomers.

Also, silicone resins including methylsilicone and methylphenylsilicone, polyester resins containing bisphenol or glycol, epoxy resins, polyurethane resins, polyamide resins, cellulose resins, polyether resins, and polycarbonate resins may also be used. These resins may be used independently or in combination of two or more thereof.

Specifically, it is preferred to use a copolymer obtained by copolymerizing, among the polymerizable monomers, a styrene such as styrene, p-chlorostyrene, or α-methylstyrene with an alkyl short-chain acrylate such as methyl acrylate or methyl methacrylate, n-propyl acrylate, n-butyl acrylate, lauryl acrylate, 2-ethylhexyl acrylate, n-propyl methacrylate, lauryl methacrylate, or 2-ethylhexyl methacrylate.

Of these binder resins, a resin containing a copolymer of styrene and an alkyl acrylate is particularly preferred in view of its low hygroscopic properties and easy suppression of gloss unevenness.

Specific examples of the crosslinking agent to be used in the exemplary embodiment include aromatic polyvinyl compounds such as divinylbenzene and divinylnaphthalene; polyvinyl esters of an aromatic polyvalent carboxylic acid, such as divinyl phthalate, divinyl isophthalate, divinyl terephthalate, divinyl homophthalate, divinyl/trivinyl trimesate, divinyl naphthalenedicarboxylate, and divinyl biphenylcarboxylate; divinyl esters of a nitrogen-containing aromatic compound, such as divinyl pyridinedicarboxylate; vinyl esters of an unsaturated heterocyclic compound, such as vinyl pyrromucinate, vinyl furancarboxylate, vinyl pyrrol-2-carboxylate, and vinyl thiophenecarboxylate; multi-functional (meth)acrylic acid esters of a linear polyhydric alcohol, such as butanediol methacrylate, hexanediol acrylate, octanediol methacrylate, decanediol acrylate, and dodecanediol methacrylate; (meth)acrylic acid esters of a branched or substituted polyhydric alcohol, such as neopentylglycol dimethacrylate and 2-hydroxy-1,3-diacryloxypropane; polyethylene glycol di(meth)acrylate and polypropylene polyethylene glycol di(meth)acrylate; and multi-functional vinyl esters of a polyvalent carboxylic acid, such as divinyl succinate, divinyl fumarate, vinyl/divinyl maleate, divinyl diglycolate, vinyl/divinyl itaconate, divinyl acetonedicarboxylater divinyl glutarate, divinyl 3,3′-thiodipropionate, divinyl/trivinyl trans-aconitate, divinyl adipate, divinyl pimelate, divinyl suberate, divinyl azelate, divinyl sebacate, divinyl dodecanedicarboxylate, and divinyl brassylate.

In the exemplary embodiment, these crosslinking agents may be used independently or in combination of two or more kinds thereof. Of the above-described crosslinking agents, (meth) acrylic acid esters of a linear polyhydric alcohol, such as butanediol methacrylate, hexanediol acrylate, octanediol methacrylate, decanediol acrylate, and dodecanediol methacrylate; (meth)acrylic acid esters of a branched or substituted polyhydric alcohol, such as neopentylglycol dimethacrylate and 2-hydroxy-1,3-diacryloxypropane; and polyethylene glycol di(meth)acrylate and polypropylene polyethylene glycol di(meth)acrylate are preferred to use, since their polymerization is slower than common polymerizable monomers.

The content of the crosslinking agent is preferably from 0.05% by weight to 5% by weight, more preferably from 0.1% by weight to 1.0% by weight, based on the total amount of the polymerizable monomers.

As the polymerization initiator to be used in the case of producing the resin for the toner of the exemplary embodiment by radical polymerization of a polymerizable monomer, there can be illustrated the following ones.

Regarding the radical polymerization initiator to be used here, there are no particular limitations. Specific examples thereof include peroxides such as hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, ammonium persulfate, sodium persulfate, potassium persulfate, diisopropyl peroxycarbonate, tetralin hydroperoxide, 1-phenyl-2-methylpropyl-1-hydroperoxide, pertriphenylacetic acid-tert-butyl-hydroperoxide, tert-butyl performate, tert-butyl peracetate, tert-butyl perbenzoate, tert-butyl phenylperacetate, tert-butyl methoxyperacetate, and tert-butyl N-(3-toluoyl)percarbamate; azo compounds such as 2,2′-azobispropane, 2,2′-dichloro-2,2′-azobispropane, 1,1′-azo(methylethyl) diacetate, 2,2′-azobis(2-amidinopropane) hydrochloride, 2,2′-azobis(2-amidinopropane) nitrate, 2,2′-azobisisobutane, 2,2′-azobisisobutylamide, 2,2′-azobisisobutylonitrile, methyl 2,2′-azobis(2-methylpropionate), 2,2′-dichloro-2,2′-azobisbutane, 2,2′-azobis-2-methylbutylonitrile, dimethyl 2,2′-azobisisobutyrate, 1,1′-azobis(sodium 1-methylbutylonitrile-3-sulfonate), 2-(4-methylphenylazo)-2-methylmalonodinitrile, 4,4′-azobis-4-cyanovaleric acid, 3,5-dihydroxymethylphenylazo-2-methylmalonodinitrile, 2-(4-bromophenylazo)-2-allylmalonodinitrile, 2,2′-azobis-2-methylvaleronitrile, dimethyl 4,4′-azobis(4-cyanovalerate), 2,2′-azobis-2,4-dimethylvaleronitrile, 1,1′-azobiscyclohexanenitriler 2,2′-azobis-2-propylbutylonitrile, 1,1′-azobis-1-chlorophenylethane, 1,1′-azobis-1-cyclohexanecarbonitrile, 1,1′-azobis-1-cycloheptanenitrile, 1,1′-azobis-1-phenylethane, 1,1′-azobiscumene, ethyl 4-nitrophenylazobenzylcyanoacetate, phenylazodiphenylmethane, phenylazotriphenylmethane, 4-nitrophenylazotriphenylmethane, 1,1′-azobis-1,2-diphenylethane, poly(bisphenol A-4,4′-azobis-4-cyanopentanoate), and poly(tetraethyleneglycol-2,2′-azobisisobutylate); 1,4-bis(pentaethylene)-2-tetrazene; and 1,4-dimethoxycarbonyl-1,4-diphenyl-2-tetrazene.

Of these, water-soluble compounds are preferred. Specific examples thereof include hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, ammonium persulfate, sodium persulfate, potassium persulfate, and diisopropyl peroxycarbonate.

In the production of the electrostatic-image-developing toner of the exemplary embodiment, a surfactant may be used for the purpose of, for example, stabilizing the system upon dispersion in the suspension polymerization process, or stabilizing a resin particle dispersion, a colorant particle dispersion, and a releasing agent dispersion in the emulsion polymerization aggregation process.

Examples of the surfactant include anionic surfactants such as sulfate ester salt type, sulfonate type, phosphate type, and soap type; cationic surfactants such as amine salt type and quaternary ammonium salt type; nonionic type surfactants such as polyethylene glycol type, alkyl phenol ethylene oxide adduct type, and polyhydric alcohol type. Among these examples, ionic surfactants are preferred, with anionic surfactants and cationic surfactants being more preferred.

In the toner of the exemplary embodiment, an anionic surfactant generally has a strong dispersing force and is excellent in dispersing the resin particles and the colorant, and hence use of the anionic surfactant as a surfactant for dispersing the releasing agent is advantageous.

Nonionic surfactants are preferably used in combination with the above-mentioned anionic surfactant or the cationic surfactant. The surfactants may be used independently or in combination of two or more thereof.

Specific examples of the anionic surfactant include fatty acid soaps such as potassium laurate, sodium oleate, and sodium castor oil; sulfate esters such as octyl sulfate, lauryl sulfate, lauryl ether sulfate, and nonyl phenyl ether sulfate; sulfonates such as lauryl sulfonate, dodecylbenzene sulfonate, sodium alkylnaphthalene sulfonate (e.g., triisopropylnaphthalene sulfonate or dibutylnaphthalene sulfonate), naphthalene sulfonate formalin condensate, monooctyl sulfosuccinate, dioctyl sulfosuccinate, lauric acid amide sulfonate, and oleic acid amide sulfonate; phosphate esters such as lauryl phosphate, isopropyl phosphate, nonyl phenyl ether phosphate; and sulfosuccinates such as dialkyl sulfosuccinate (e.g., sodium dioctyl sulfosuccinate), and disodium lauryl sulfosuccinate.

Specific examples of the cationic surfactant include amine salts such as laurylamine hydrochloride, stearylamine hydrochloride, oleylamine acetate, stearylamine acetate, and stearylaminopropylamine acetate; and quaternary ammonium salts such as lauryltrimethylammonium chloride, dilauryldimethylammonium chloride, distearyldimethylammonium chloride, lauryldihydroxyethylmethylammonium chloride, oleylbispolyoxyethylenemethylammonium chloride, lauroylaminopropyldimethylethylammonium ethosulfate, lauroylaminopropyldimethylhydroxyethylanmonium perchlorate, alkylbenzenetrimethylammonium chloride, and alkyltrimethylammonium chloride.

Specific examples of the nonionic surfactant include alkyl ethers such as polyoxyethylene octyl ether, polyoxyethylene lauryl ether, polyoxyethylene stearyl ether, and polyoxyethylene oleyl ether; alkyl phenyl ethers such as polyoxyethylene octyl phenyl ether and polyoxyethylene nonyl phenyl ether; alkyl esters such as polyoxyethylene laurate, polyoxyethylene stearate, and polyoxyethylene oleate; alkylamines such as polyoxyethylene lauryl aminoether, polyoxyethylene stearyl aminoether, polyoxyethyelne oleyl aminoether, polyoxyethylene soybean aminoether, and polyoxyethylene beef tallow aminoether; alkylamides such as polyoxyethylene lauric acid amide, polyoxyethylene stearic acid amide, and polyoxyethylene oleic acid amide; vegetable oil ethers such as polyoxyethylene castor oil ether and polyoxyethylene rapeseed oil ether; alkanolamides such as lauric acid diethanol amide, stearic acid diethanol amide, and oleic acid diethanol amide; and sorbitan ester ethers such as polyoxyethylene sorbitan monolaurate, polyoxyethylene sorbitan monopalmitate, polyoxyethylene sorbitan monostearate, and polyoxyethylene sorbitan monooleate.

The content of the surfactant in each dispersion may be at a level at which the surfactant does not inhibit the effect of the exemplary embodiment, and is generally at a small level, specifically in the range of from 0.01% by weight to 10% by weight, more preferably from 0.05% by weight to 5% by weight, still more preferably from 0.1% by weight to 2% by weight. In case when the content is less than 0.01% by weight, each of the resin particle dispersion, the colorant dispersion, and the releasing agent dispersion becomes unstable and, as a result, aggregation occurs in some cases or, since particles are different from each other in stability upon aggregation, separation of particular particles occurs in some cases. On the other hand, in case when the content exceeds 10% by weight, there results a broad particle size distribution or it becomes difficult to control the particle diameter of the resulting particles in some cases. In general, a suspension-polymerized toner dispersion having a large particle diameter is stable even when the content of the used surfactant is small.

As the dispersion stabilizer which can be used in the aforesaid suspension polymerization process, a scarcely water-soluble, hydrophilic inorganic powder can be used. Examples of the inorganic powder which can be used include silica, alumina, titania, calcium carbonate, magnesium carbonate, tricalcium phosphate (hydroxyapatite), clay, diatomaceous earth, and bentonite. Of these, calcium carbonate and tricalcium phosphate are preferred in view of easiness for forming particles with a desired particle size and easiness of their removal.

Also, an aqueous polymer which is solid at ordinary temperature may be used as the dispersion stabilizer. Specific examples thereof include cellulose-typed compounds such as carboxymethyl cellulose and hydroxypropyl cellulose, polyvinyl alcohol, gelatin, starch, and arabic gum.

In the case of using the emulsion polymerization aggregating process for producing the toner in the exemplary embodiment, particles can be prepared by causing aggregation in the aggregating step by changing the pH. An aggregating agent may be added for the purpose of causing aggregation of particles stably and rapidly or obtaining aggregated particles having a narrower particle size distribution.

As the aggregating agent, compounds having at least a monovalent charge are preferred, and specific examples thereof include water-soluble surfactants such as the aforesaid ionic surfactants and nonionic surfactants; acids such as hydrochloric acid, sulfuric acid, nitric acid, acetic acid, and oxalic acid; metal salts of inorganic acids, such as magnesium chloride, sodium chloride, aluminum sulfate, calcium sulfate, ammonium sulfate, aluminum nitrate, silver nitrate, copper sulfate, and sodium carbonate; metal salts of aliphatic acids or aromatic acids, such as sodium acetate, potassium formate, sodium oxalate, sodium phthalate, and potassium salicylate; metal salts of phenols, such as sodium phenolate; metal salts of amino acids; and inorganic acid salts of aliphatic or aromatic amines, such as triethanolamine hydrochloride and aniline hydrochloride.

In consideration of stability of aggregated particles, stability of the aggregating agent against heat or with lapse of time, and removal upon washing, metal salts of inorganic acids are preferred as the aggregating agents in view of performance and easy-to-use convenience. Specific examples thereof include metal salts of inorganic acids, such as magnesium chloride, sodium chloride, aluminum sulfate, calcium sulfate, ammonium sulfate, aluminum nitrate, silver nitrate, copper sulfate, and sodium carbonate.

The addition amount of the aggregating agent varies depending upon the number of valence of charge. However, the addition amount is set to a small level of about 3% by weight or less with a monovalent aggregating agent, about 1% by weight or less with a divalent aggregating agent, and about 0.5% by weight or less with a trivalent aggregating agent. A smaller addition amount of the aggregating agent is more preferred, and hence compounds having a higher number of valence are more preferably used.

As the colorant which can be used in the exemplary embodiment, pigments can be used. Also, dyes may be used as needed.

Examples of the pigments which can be used as colorants in the exemplary embodiment include the following ones.

Examples of yellow pigment include lead yellow, zinc yellow, yellow calcium oxide, cadmium yellow, chrome yellow, Hansa Yellow, Hansa Yellow 10G, benzidine yellow G, benzidine yellow GR, threne yellow, quinoline yellow, and permanent yellow NCG. Specific examples thereof include C.I. pigment yellow 74, C.I. pigment yellow 180, and C.I. pigment yellow 93, with C.I. pigment yellow 74 being preferred in view of pigment dispersibility. As the yellow pigment, the above-described pigments may be used independently or in combination of two or more thereof.

Examples of black pigment include carbon black, copper oxide, manganese dioxide, aniline black, activated carbon, non-magnetic ferrite, and magnetite.

Examples of orange pigment include reddish yellow lead, molybdenum orange, permanent orange CTR, pyrazolone orange, vulcan orange, benzidine orange G, indathrene brilliant orange RK, and indathrene brilliant orange CK.

Examples of red pigment include red iron oxide, cadmium red, red lead, mercury sulfide, Watchung red, permanent red 4R, lithol red, brilliant carmine 3B, brilliant carmine 6B, Du pont oil red, pyrazolone red, rhodamine B lake, lake red C, rose bengale, eoxine red, and alizarine lake.

Examples of blue pigment include prussian blue, cobalt blue, alkali blue lake, victoria blue lake, fast sky blue, indathrene blue BC, aniline blue, ultramarine blue, chalco oil blue, methylene blue chloride, phthalocyanine green, and malachite green oxalate.

Examples of purple pigment include manganese violet, fast violet B, and methyl violet lake.

Examples of green pigment include chromium oxide, chromium green, pigment green, malachite green lake, and final yellow green G.

Examples of white pigment include zinc oxide, titanium oxide, antimony white, and zinc sulfide.

Examples of extender pigment include barytes powder, bariumcarbonate, clay, silica, white carbon, talc, andalumina white.

Also, a dye may be used as the colorant as needed. Examples of such dye include various dyes such as basic dyes, acidic dyes, disperse dyes, and direct cotton dyes. Specific examples thereof include nigrosine, methylene blue, rose bengale, quinoline yellow, and ultramarine blue. These dyes may be used independently or as a mixture thereof or, further, in a solid solution state.

Of these colorants, Pigment Yellow 74 is preferred in the point that it facilitates to suppress gloss unevenness.

These colorants are dispersed by a known method. For example, a method of using a revolving shearing homogenizer, a media type disperser such as a ball mill, a sand mill, or an attritor, or a high pressure counter collision type disperser is preferably employed.

These colorants can also be dispersed in an aqueous system by using a polar surfactant and the aforesaid homogenizer.

A proper colorant is selected in view of hue angle, color saturation, lightness, weatherability, and dispersibility in a toner. The colorant is added in an amount of preferably from about 1 part by weight to about 20 parts by weight per 100 parts by weight of the resin.

In the case of using a magnetic material as a black colorant, it is preferred to add in a proportion of from 30 parts by weight to 100 parts by weight as is different with other colorants.

Also, in the case of using the toner as a magnetic toner, a magnetic powder may be incorporated in the toner. As such magnetic powder, a substance which can be magnetized in the magnetic field is used. Examples thereof include powder of ferromagnetic substance such as iron, cobalt, or nickel, and compounds such as ferrite and magnetite.

In the exemplary embodiment, it is preferred to pay attention to the migration properties of the magnetic material into an aqueous phase for the purpose of obtaining a toner in an aqueous phase. Thus, it is preferred to subject the magnetic material to a surface-modifying treatment such as a hydrophobicity-imparting treatment.

In the exemplary embodiment, a releasing agent is added to the toner. As the releasing agent, any material that has a melting temperature of from 70° C. to 100° C. can be used with no particular limitations. Specific examples of the releasing agent which can be used include a low molecular polyolefin such as polyethylene, polypropylene, or polybutene; a silicone showing a softening temperature; an fatty acid amide such as oleic acid amide, erucic acid amide, ricinoleic acid amide, or stearic acid amide; a plant wax such as carnauba wax, rice wax, candelilla wax, Japanese wax, or jojoba oil; an animal wax such as bee wax; a mineral-petroleum wax such as montan wax, ozokerite, ceresini paraffin wax, microcrystalline wax, or Fischer-Tropsch wax; an ester wax between a higher fatty acid and a higher alcohol, such as stearyl stearate or behenyl behenate; an ester wax between a higher fatty acid and a monohydric or polyhydric lower alcohol, such as butyl stearate, propyl oleate, monostearic acid glyceride, distearic acid glyceride, or pentaerythrltol tetrabehenate; an ester wax between a higher fatty acid and a polyhydric alcohol multimer, such as diethylene glycol monostearate, dipropylene glycol distearate, distearic acid diglyceride, or tetrastearic acid triglyceride; an ester wax between sorbitan and a higher fatty acid, such as sorbitan monostearate; and an ester wax between cholesterol and a higher fatty acid, such as cholesteryl stearate. These releasing agents may be used independently or in combination of two or more thereof.

The releasing agent is preferably a hydrocarbon-typed wax. The hydrocarbon-typed wax has a low polarity and is considered to be scarcely susceptible to the plasticizing effect of a highly polar water vapor. In the case of using other releasing agent than the hydrocarbon-typed wax, it is susceptible to the influence of water vapor due to its polarity and can generate gloss unevenness when plasticized. of the hydrocarbon-typed waxes, a mineral-petroleum wax such as paraffin wax, microcrystalline wax, and Fischer-Tropsch wax; and the modified products thereof, i.e., polyalkylene waxes are more preferred in the point of melting-out uniformity onto the surface of a fixed image and an appropriate thickness of the releasing agent. Still more preferably, the hydrocarbon-typed waxes are paraffin-typed waxes. Paraffin-typed waxes have a high crystallinity and can more suppress plasticizing effect of water vapor, and hence the fixed image scarcely generates gloss unevenness.

The content of the colorant in the case of mixing the resin, the colorant, and the releasing agent is preferably 50% by weight or less, more preferably in the range of from about 2% by weight to about 40% by weight.

[Shell Layer-Forming Step]

In the shell layer-forming step which is conducted as needed, resin particles are deposited on the surface of the core-forming aggregated particles by using a resin particle dispersion containing the resin particles to thereby form a coating layer (shell layer) having a desired thickness. Thus, aggregated particles (core/shell aggregated particles) having a core/shell structure wherein a shell layer is formed on the surface of the core-forming aggregated particles are obtained.

Incidentally, the aggregating step and the shell layer-forming step may repeatedly be conducted stepwise in several sub-steps.

Here, the volume-average particle diameter of the resin particles, the colorant particles, and the releasing agent particles to be used in the aggregating step and the shell layer-forming step is preferably 1 μm or less, more preferably in the range of from 100 nm to 300 nm in order to facilitate adjustment of the toner diameter and the particle size distribution to desired levels.

The volume-average particle diameter is measured by using a laser diffraction particle size distribution analyzer (LA-700; manufactured by Horiba, Ltd.) The measurement method involves adjusting the dispersion-state sample so that the solid fraction of the sample is about 2 g, and then adding deionized water to make the sample up to about 40 ml. This sample is then added to the cell in sufficient quantity to generate a suitable concentration, and the sample is allowed to stand for about 2 minutes until the concentration within the cell is substantially stabilized, followed by conducting the measurement. The volume average particle size for each of the obtained channels is accumulated beginning at the smaller volume average particle sizes, and the point where the accumulated value reaches 50% is defined as the volume average particle size.

[Stopping Step]

In the stopping step, growth of aggregation of aggregated particles is stopped by adjusting the pH of the aggregation system. Specifically, the pH of the aggregation system is adjusted to the range of from 5 to 10, preferably from 6 to 9, to stop growth of the aggregated particles.

[Fusing Step]

In the fusing step (fuse-coalescing step), toner particles are obtained by heating a solution containing aggregated particles, which have been obtained through the aggregating step and, as needed, the shell-forming step, to a temperature equal to, or higher than, the melting temperature of the resin particles contained in the aggregated particles.

[Washing Step]

In the washing step, the toner particle dispersion obtained by the coalescing step is at least subjected to substitution washing with deionized water, followed by solid-liquid separation. The method for solid-liquid separation is not particularly limited but, in view of productivity, suction filtration or pressure filtration is preferably employed.

[Drying Step]

In the drying step, the wet cake obtained by solid-liquid separation is dried to obtain toner particles. The drying method is not particularly limited but, in view of productivity, freeze-drying, flush-jet drying, fluidized drying, or fluidized drying under shake is preferably used.

In the exemplary embodiment, other components (particles) than the aforesaid resin, colorant, and releasing agent, such as internal additives, charge controlling agents, organic particles, lubricants, and abrasives may be added, as needed, in addition to the aforesaid resin, colorant, and releasing agent.

Examples of the internal additives include magnetic materials such as ferrite, magnetite, reduced iron, metals such as cobalt, manganese, and nickel, the alloys thereof, and the compounds containing these metals. These can be used in an amount not adversely affecting charging properties of toner properties.

The charge controlling agents are not particularly limited but, particularly in the case of using a color toner, colorless or slightly colored ones are preferably used. Examples thereof include quaternary ammonium salt compounds, Nigrosine compounds, dyes comprising a complex of aluminum, iron or chromium, and triphenylmethane pigments.

Examples of the organic particles include all of those organic particles which are commonly used as external additives for the surface of the toner, such as vinyl resin, polyester resin, and silicone resin. Additionally, these inorganic particles or organic particles can be used as a flowability aid, a cleaning aid, or the like.

Examples of the lubricants include fatty acid amides such as ethylenebisstearic acid amide and oleic acid amide, and fatty acid metal salts such as zinc stearate and calcium stearate.

Examples of the abrasives include the aforesaid silica, alumina, and cerium oxide.

The contents of the other components may be such that they do not spoil the effects of the exemplary embodiment, and are generally at an extremely small level. Specifically, the contents are preferably in the range of from 0.01% by weight to 5% by weight, more preferably from 0.5% by weight to 2% by weight.

The toner to be used in the exemplary embodiment may have at least one or more kinds of metal oxide particles on the surface thereof. Specific examples of the metal oxide particles include silica, titania, zinc oxide, strontium oxide, aluminum oxide, calcium oxide, magnesium oxide, cerium oxide, and the composite oxides thereof. Of these, silica and titania are preferably used in view of particle diameter, particle size distribution, and productivity.

The volume-average particle diameter of the metal oxide particles is preferably in the range of from about 1 nm to about 40 nm, more preferably in the range of from about 5 nm to about 20 nm, in terms of primary particle diameter.

These metal oxide particles may be used independently or as a mixture of plural kinds of them. Also, the addition amount of them to the toner is not particularly limited, but is preferably in the range of from about 0.1% by weight to about 10% by weight, more preferably in the range of from about 0.2% by weight to about 8% by weight. In case when the addition amount of the metal oxide particles is less than 0.1% by weight, the effects of the added metal oxide are difficult to obtain whereas, when exceeding 10% by weight, a sufficient image density is not obtained in some cases.

These metal oxide particles are preferably subjected to surface-modifying treatment such as hydrophobicity-imparting treatment, which serves to facilitate entering of the particles into the releasing agent layer upon fixing and, as a result, inhibit crystallization of the releasing agent. As means for the surface modification, conventionally known treatments may be employed. Specific examples thereof include coupling treatments using a silane, a titanate, or an aluminate.

The electrostatic-image-developing toner of the exemplary embodiment has a toner shape factor SF1 of preferably from about 125 to about 140 (provided that the shape factor SF1 of a toner (ML²/A)×(π/4)×100 wherein ML represents the maximum length (μm) of the toner, and A represents the projected area (μm²) of the toner). In the case when the toner shape factor is between 125 and 140, a fixed image with less gloss unevenness can be obtained owing to stable transfer properties, thus stable color reproducibility being liable to be obtained. In case when the shape factor is less than 125, transfer properties enhance so much in an environment of low temperature and low humidity that it becomes difficult to satisfactory use the toner, i.e., the toner is not deposited uniformly onto the image to be fixed, thus color reproducibility being deteriorated in some cases. In case when the shape factor exceeds 140, there results reduced transfer properties, and the toner is not deposited in a desired amount on the image to be fixed, which leads to unevenness in the amount of the toner deposited on the image to be fixed, thus gloss unevenness occurring in some cases.

Also, regarding the particle diameter distribution index in the exemplary embodiment, the volume average particle size distribution index GSDv is preferably about 1.30 or less, and the ratio of the number average particle size distribution index GSDp to the volume average particle size distribution index GSDv (GSDp/GSDv) is preferably 0.95 or more. In case when the volume average particle size distribution index GSDv exceeds 1.30, the surface unevenness of the fixed image becomes so large that, in some cases, unevenness occurs on the fixed image. In case when the ratio of the number average particle size distribution index to the volume average particle size distribution index GSDv is less than 0.95, it means that the amount of smaller-diameter toner increases, and the amount of ethylenediaminedisuccinic acid per one toner tends to vary and, as a result, gloss unevenness occurs in some cases.

The surface area of the electrostatic-image-developing toner of the exemplary embodiment is not particularly limited, and the range of the surface area may be that of particles which can be used for the common toner. Specifically, the surface area measured by BET method is preferably in the range of from about 0.5 m²/g to about 10 m²/g, more preferably from about 1.0 m²/g to about 7 m²/g, still more preferably from about 1.2 m²/g to about 5 m²/g, yet more preferably from about 1.2 m²/g to about 3 m²/g.

<Electrostatic Image Developer>

The electrostatic image developer in accordance with the exemplary embodiment is not particularly limited except for containing the electrostatic-image-developing toner of the exemplary embodiment, and a proper component formulation can be employed depending upon the purpose. When the electrostatic-image-developing toner of the exemplary embodiment is independently used, there is prepared a one-component electrostatic image developer (hereinafter also referred to “one-component developer”) and, when used in combination with a carrier, there is prepared a two-component electrostatic image developer (hereinafter also referred to as “two-component developer”).

The carrier in the case of using a carrier is not particularly limited, and examples thereof include known carriers. For example, there are illustrated resin-coated carriers including a core material and resin-coating layer prepared by coating the core material with a coating resin, which are described in JP-A-62-39879, JP-A-56-11461, etc. Also, the carrier may be a resin dispersion type carrier comprising a matrix resin containing dispersed therein an electrically conductive material.

Specific examples of the carrier include the following resin-coated carriers. As core particles for the carrier, there are illustrated common iron powder, shaped ferrite, and shaped magnetite. The volume-average particle diameter is usually in the range of from about 30 μm to about 200 μm.

Also, examples of the coating resin for the resin-coated carrier include homopolymers of, or copolymers comprising two or more kinds of, monomers such as styrenes (e.g., styrene, p-chlorostyrene, and α-methylstyrene), α-methylene fatty acid monocarboxylic acids (e.g., methyl acrylate, ethyl acrylate, n-propyl acrylate, lauryl acrylate, 2-ethylhexyl acrylate, methyl methacrylate, n-propyl methacrylate, lauryl methacrylate, and 2-ethylhexyl methacrylate), nitrogen-containing acrylic compounds (e.g., dimethylaminoethyl methacrylate), vinylniriles (e.g., acrylonitrile and methacrylonitrile), vinylpyridines (e.g., 2-vinylpyridine and 4-vinylpyridine), vinyl ethers (e.g., vinyl methyl ether and vinyl isobutyl ether), vinyl ketones (e.g., vinyl methyl ketone, vinyl ethyl ketone, and vinyl isopropenylketone), olefins (e.g., ethylene and propylene), and vinyl-typed, fluorine-containing monomers (e.g., vinylidene fluoride, tetrafluoroethylene, and hexafluoroethylene) and, further, silicone resins (e.g., methyl silicone and methylphenyl silicone); polyesters containing bisphenol or glycol; epoxy resins; polyurethane resins; polyamide resins; cellulose resins; polyether resins; and polycarbonate resins. These resins may be used independently or in combination of two or more thereof. The coating amount of the coating resin is preferably in the range of from about 0.1 part by weight to about 10 parts by weight, more preferably from about 0.5 part by weight to about 3.0 parts by weight, per 100 parts by weight of the core particles.

In the exemplary embodiment, the coating resin for the carrier is preferably a resin containing a copolymer of styrene an methyl methacrylate in view of suppressing gloss unevenness and achieving uniform development.

For producing the carriers, a heating kneader, a heating Henschel mixer, a UM mixer, or the like can be used and, depending upon the amount of the coating resin, a heating type fluidized rolling bed, a heating type kiln, or the like can be used.

The mixing ratio of the electrostatic-image-developing toner of the exemplary embodiment to the carrier to be used in the electrostatic image developer is not particularly limited and can properly be selected according to the purpose.

<Image-Forming Apparatus>

The image-forming apparatus in accordance with the exemplary embodiment includes an image-holding member, a latent-image-forming unit for forming a latent image on the surface of the image-holding member, a developing unit for developing the latent image by using an electrostatic-image-developing toner, and a transfer unit for transferring the developed toner image onto a transfer-receiving material, with the electrostatic-image-developing toner being the electrostatic-image-developing toner described hereinbefore. The image-forming apparatus in accordance with the exemplary embodiment may further include other units than the above-described units, such as a charging unit for charging the image-holding member, a fixing unit for fixing the toner image transferred onto the surface of a transfer-receiving material, and a cleaning unit for removing the toner remaining on the surface of the image-holding member.

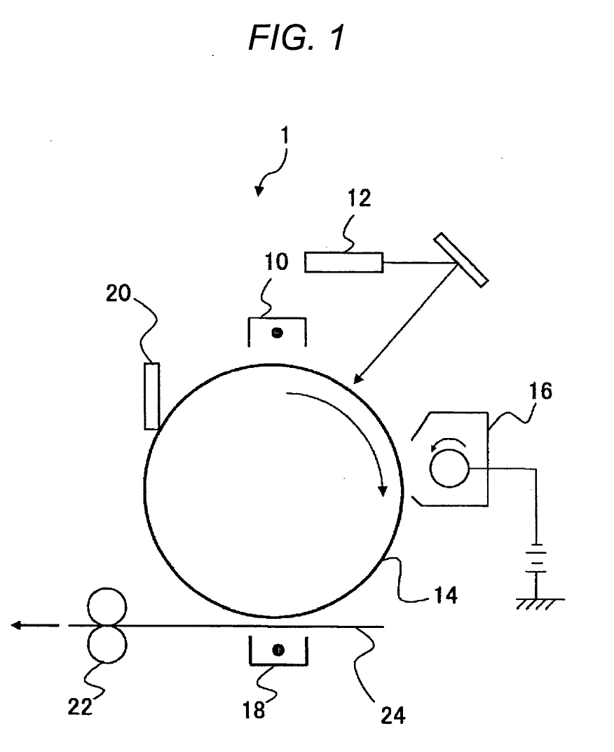

One example of the image-forming apparatus of the exemplary embodiment is schematically shown in FIG. 1. The constitution of the apparatus will be described below. An image-forming apparatus 1 is equipped with a charging station 10, an exposing station 12, an image-holding member of an electrophotographic photoreceptor 14, a developing station 16, a transfer station 18, a cleaning station 20, and a fixing station 22.

In the image-forming apparatus 1, there are provided, around the electrophotographic photoreceptor 14 in the following order, the charging station 10 for charging the surface of the electrophotographic photoreceptor 14; the exposing station 12 which constitutes the latent-image-forming unit for forming an electrostatic latent image according to image information by exposing the charged electrophotographic photoreceptor 14; the developing station 16 which constitutes the developing unit for forming a toner image by developing the electrostatic latent image with a toner; the transfer station 18 which constitutes the transfer unit for transferring the toner image formed on the surface of the electrophotographic photoreceptor 14 to the surface of the transfer-receiving material 24; and the cleaning station 20 which constitutes the cleaning unit for removing the toner remaining on the surface of the electrophotographic photoreceptor 14 after the transfer station. Also, the fixing station 22 which constitutes the fixing unit for fixing the toner image transferred to the transfer-receiving material 24 is disposed on the left side of the transfer station 18.

Operation of the image-forming apparatus 1 in accordance with the exemplary embodiment will be described below. First, the surface of the electrophotographic photoreceptor 14 is uniformly charged in the charging station 10 (charging step). Then, the surface of the electrophotographic photoreceptor 14 is exposed with light in the exposing station 12 to remove the charge in the light-struck area, thus an electrostatic image (latent image) corresponding to image information being formed (latent image-forming step). Thereafter, the electrostatic latent image is developed in the developing station 16 to form a toner image on the surface of the electrophotographic photoreceptor 14 (developing step). For example, with a digital-system electrophotographic copier using an organic photoreceptor as the electrophotographic photoreceptor 14 and using a laser beam light in the exposing station 12, the surface of the electrophotographic photoreceptor 14 is negatively charged in the charging station 10, a digital latent image in a dot pattern is formed by the laser beam light, and a toner is applied to the laser beam light-struck area in the developing station 16, thus the latent image being visualized. In this case, a minus bias is applied to the developing station 16. Subsequently, in the transfer station 18, the transfer-receiving material 24 such as paper is superimposed on the toner image, and a charge of reverse polarity to that of the toner is applied to the transfer-receiving material 24 from the backside of the transfer-receiving material 24, thus the toner image being transferred to the transfer-receiving material 24 due to electrostatic force (transfer step). The thus-transferred toner image is fused and fixed to the transfer-receiving material 24 by applying heat and pressure with a fixing member in the fixing station 22 (fixing step). On the other hand, a toner not having been transferred but remaining on the surface of the electrophotographic photoreceptor 14 is removed in the cleaning station 20 (cleaning step). A series of the procedures of from charging to cleaning constitute one cycle. Additionally, in FIG. 1, while the toner image is directly transferred to the transfer-receiving material 24 such as paper in the transfer station 18, the toner image may be transferred via a transfer member such as an intermediate transfer member.

The charging unit, the image-holding member, the exposing unit, the developing unit, the transfer unit, the cleaning unit, and the fixing unit for the image-forming apparatus 1 shown in FIG. 1 will be described below.

(Charging Unit)

As the charging station 10 which constitutes the charging unit, a charger such as corotron as shown in FIG. 1 is used. Alternatively, an electrically conductive or semi-conductive charging roll may be used. In using a contact type charger using an electrically conductive or semi-conductive charging roll, a direct current may be applied to the electrophotographic photoreceptor 14, or an alternating current may be superposed on the direct current and the resulting current may be applied. For example, electric discharge is generated in the micro-space in the vicinity of the contact portion between the charger 10 and the photoelectric receptor 14, thus the surface of the photoelectric receptor 14 being charged. Additionally, the surface is usually charged to −300 to −1,000 V. Also, the electrically conductive or semi-conductive charging roll may have a mono-layer structure or a multi-layer structure. Further, a mechanism for cleaning the surface of the charging roll may be provided.

(Image-Holding Member)

The image-holding member has at least the function of forming a latent image (electrostatic latent image). As the image-holding member, an electrophotographic photoreceptor is illustrated. The electrophotographic photoreceptor 14 comprises a cylindrical, electrically conductive substrate having on the outer surface thereof a coating film containing an organic photo-sensitive substance. The coating film has been formed by forming an undercoating layer (as needed), a charge generating layer containing a charge generating substance, and a charge transporting layer containing a charge transporting substance in this order. The stacking order of the charge generating layer and the charge transporting layer may be reversed. This is a layered photoreceptor wherein the charge generating substance and the charge transporting substance are incorporated in different layers (charge generating layer and charge transporting layer), but a single-layered photoreceptor wherein both the charge generating substance and the charge transporting substance are incorporated in one and the same layer may be employed, with the layered photoreceptor being preferred. Also, an intermediate layer may be provided between the undercoating layer and the photo-sensitive layer. Further, not only the organic photo-sensitive layer but other kinds of photo-sensitive layers such as an amorphous silicon photo-sensitive layer may be employed.

(Exposing Unit)

The exposing station 12 which constitutes the exposing unit is not particularly limited and, for example, there are illustrated optical devices capable of imagewise exposing the image-holding member in a desired manner with a light such as a semiconductor laser light, an LED light, or a liquid-crystal shutter light.

(Developing Unit)

The developing station 16 which constitutes the developing unit has the function of developing the latent image formed on the image-holding member with a toner-containing developer to form a toner image. Such developing device is not particularly limited so long as it has the above-mentioned function, and a proper one can be selected according to the purpose. There are illustrated, for example, known developing devices which have the function of depositing an electrostatic-image-developing toner onto the electrophotographic photoreceptor 14 using a brush or a roller. A direct current voltage is usually applied to the electrophotographic photoreceptor 14, but an alternating current voltage may be superposed on the direct current voltage to use.

(Transfer Unit)

As the transfer station 18 which constitutes the transfer unit, there can be used, for example, a unit wherein a charge of the reverse polarity to that of the toner is applied from the backside of the transfer-receiving material 24 to thereby transfer the toner image to the transfer-receiving material 24 by electrostatic force, as shown in FIG. 1, and a unit wherein a transfer roll and a transfer roll-pressing device are provided and wherein an electrically conductive or semi-conductive roll capable of directly contacting the surface of the transfer-receiving material 24 is used to transfer the toner image to the transfer-receiving material 24. To the transfer roll may be applied, as a transfer current to be imparted to the image-holding member, a direct current or a direct current to which an alternating current is superposed. The transfer roll may arbitrarily be set according to the image-recording area to be charged, the shape of the transfer-charger, the width of the opening, and the process speed (peripheral speed). Also, for reducing the production cost, a single-layered foamed roll is preferably used as the transfer roll. As a transfer system, either of a direct transfer system of directly transferring to the transfer-receiving material 24 such as paper and a transfer system of transferring to the transfer-receiving material 24 via an intermediate transfer member may be employed.

As the intermediate transfer member, known intermediate transfer members may be used. Examples of the material to be used for the intermediate transfer member include polycarbonate resin (PC), polyvinylidene fluoride (PVDF), polyalkylene phthalate, PC/polyalkylene terephthalate (PAT) blend material, ethylene-tetrafluoroethylene copolymer (ETFE)/PC blend material, ETFE/PAT blend material, and PC/PAT blend material. In view of mechanical strength, an intermediate transfer belt using a thermoset polyimide resin is preferred.

(Cleaning Unit)

As the cleaning station 20 which constitutes the cleaning unit, any of a blade cleaning system, a brush cleaning system, and a roll cleaning system may properly be selected to use so long as it can remove the residual toner on the image-holding member. Of these, a cleaning blade system is preferred to use. Materials for the cleaning blade include urethane rubber, neoprene rubber, silicone rubber, etc. Of these, a polyurethane elastic member is preferred to use due to its excellent abrasion resistance. However, in the case of using a toner showing high transfer efficiency, an embodiment is possible wherein the cleaning station 20 is not provided.

(Fixing Unit)

The fixing station 22 which constitutes the fixing unit (image-fixing device) functions to fix the toner image transferred onto the transfer-receiving material 24 by applying heat, pressure, or both of them and is equipped with a fixing member.

(Transfer-Receiving Material)

As the transfer-receiving material (paper) 24 onto which the toner image is transferred, there are illustrated, for example, plain paper, OHP sheet, etc. which can be used for an electrophotographic copier or printer. In order to further improve smoothness of the image surface after fixing, the surface of the transfer-receiving material is preferably as smooth as possible. For example, coated paper prepared by coating the surface of plain paper with a resin, art paper for printing, etc. can preferably be used.

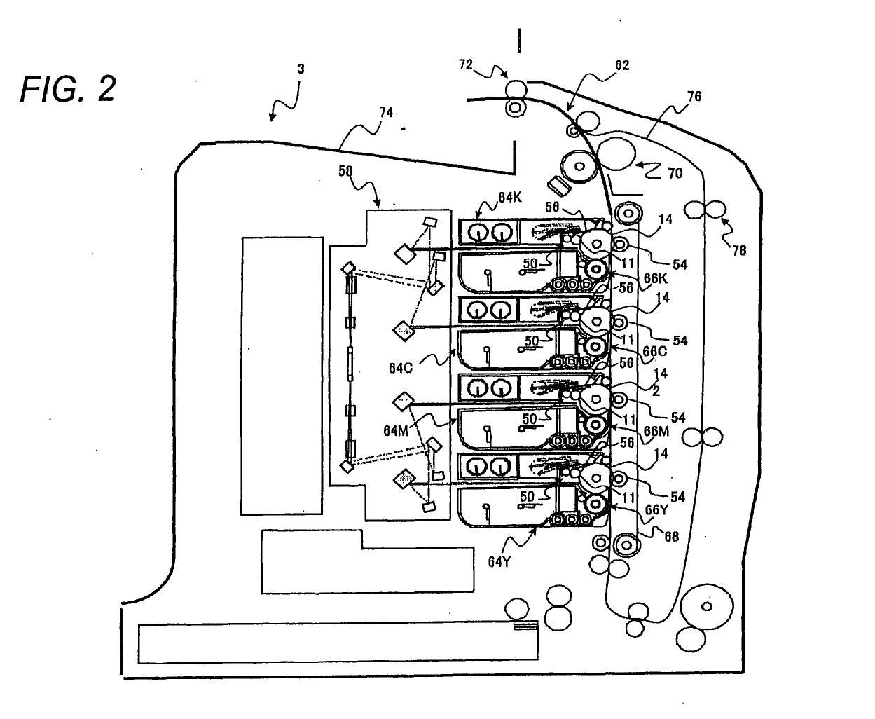

FIG. 2 shows a tandem-system full-color image-forming apparatus 3 as other example of the image-forming apparatus in accordance with the exemplary embodiment. Inside the image-forming apparatus 3 are provided image-forming units for yellow (64Y), magenta (64M), cyan (64C), and black (64K), each having an electrophotographic photoreceptor 14 and a developing device. As the electrophotographic photoreceptor 14, for example, an electrically conductive cylinder whose surface is coated with a light-sensitive layer containing an organic photo-conductive substance is used, and is rotationally driven at a process speed of, for example, about 150 mm/sec by means of a motor not shown.

The surface of the electrophotographic photoreceptor 14 charged to a predetermined potential by means of a charging roll 11 provided in contact with the electrophotographic photoreceptor 14, and is imagewise exposed with a laser beam emitted from an exposing device 58 to thereby form an electrostatic latent image corresponding to image information.

The electrostatic latent image formed on the electrophotographic photoreceptor 14 is developed in the developer 66Y, 66M, 66C or 66K for yellow (Y), magenta (M), cyan (C), or black (K) to form a toner image of predetermined color.

For example, in the case of forming a full-color image, the surface of the electrophotographic photoreceptor 14 for each color of yellow (Y), magenta (M), cyan (C), and black (K) is subjected to the charging step, the exposing step, and the developing step, thus toner images of the colors of yellow (Y), magenta (M), cyan (C), and black (K) being formed on the surfaces of the corresponding electrophotographic photoreceptors 14, respectively.

The toner images of the colors of yellow (Y), magenta (M), cyan (C), and black (K) sequentially formed on the electrophotographic photoreceptors 14 are sequentially transferred onto a recording paper 62 held on the paper-conveying belt 68, and the recording paper 62 on which the toner images are transferred is conveyed into a fixing device 70. The toner images are heated and pressed in the fixing device 70 to fix on the recording paper 62. Thereafter, in the case of one-side printing, the recording paper 62 on which the toner images are fixed is discharged as it is on a discharge tray 74 provided in the upper part of the image-forming apparatus 3 by means of a discharge roll 72.

On the other hand, in the case of two-side printing, the recording paper 62 having a toner image on the first side (surface side) fixed in the fixing apparatus 70 is not discharged onto the discharge tray 74 by means of the discharge roll 72, but is again conveyed to the transfer position of the paper-conveying belt 68 in an inverted state by reversely rotating the discharge roll 72 with nipping the latter end of the recording paper 62 by means of the discharge roll 72, exchanging the conveying path for the recording paper 62 to a conveying path 76 for two-side printing, and conveying the inversed recording paper by means of the conveying roll 78 provided on the paper-conveying path, followed by transferring toner images on the second surface (backside surface) of the recording paper 62. Then, the toner images on the second surface (backside surface) of the recording paper 62 are fixed in the fixing device 70, and the recording paper 62 is discharged onto the discharge tray 74.

Incidentally, after completion of the toner image-transfer step, the surface of the electrophotographic photoreceptor 14 is cleaned by a cleaning blade 56 disposed at a position slantingly above the electrophotographic photoreceptor 14 every rotation of the electrophotographic photoreceptor 14 to thereby remove residual toner and paper dust and prepare for the subsequent image-forming process.

The charging roll 11 provided in the image-forming apparatus 3 is equipped with a cleaning roll 50. The cleaning roll is rotatably supported by a supporting member or the housing not shown at the periphery thereof. A voltage is applied from a high-voltage electric power source to the bearing so that the cleaning roll 50 can have electrically the same polarity as that of the charging roll 11, whereby foreign matter can be removed and recovered by the cleaning blade 56 without accumulating on the surface of the cleaning roll 50 and the charging roll 11.

Regarding the constitution of the image-forming apparatus 3 in accordance with the exemplary embodiment, constituents conventionally known as constituents for an electrophotographic image-forming apparatus can be employed apart from the constitution of the exemplary embodiment. That is, for example, conventionally known charging units, charging member-cleaning devices, latent-image-forming units, developing units, transfer units, image-holding member-cleaning units, erasing units, paper-feeding units, conveying units, and image-controlling units may properly be employed as needed. These constituents are not particularly limited in the exemplary embodiment.

Since the electrostatic image developer containing the aforesaid toner is used in the image-forming apparatus and the image-forming method in accordance with the exemplary embodiment, there can be realized formation of a fixed image with high gloss and less gloss unevenness.

### EXAMPLES

The invention will be described in more detail below by reference to Examples and Comparative Examples which, however, are not to be construed as limiting the invention.

<Measuring Methods>

(Toner Shape Factor)

The toner shape factor SF1 is measured in the following manner using a Luzex image analyzer (manufactured by Nireco Corporation; FT). First, optical microscope images of the toners spread on a slide glass are incorporated into the Luzex image analyzer through a video camera, then the maximum length (ML) and the projection area (A) of a toner are measured with 50 toner particles, (ML²/A)×(π/4)×100 is calculated for each toner, and the thus-obtained values are averaged to determine the shape factor SF1.

(Toner Particle Size)

The volume average diameter D50v, the volume average particle size distribution index GSDv, and the number average particle size distribution index GSDp are obtained by measuring using Coulter Multisizer II (manufactured by Beckmann Coulter) with an aperture diameter of 100 μm. In this occasion, the measurement is conducted after the toner is dispersed in an electrolyte aqueous solution (isoton solution), followed by subjecting to ultrasonic wave dispersion for 30 seconds or more. A cumulative distribution curve is drawn from the smaller size side for each of the volume and the number of toner particles classified according to a particle size range (channel) divided based on the particle size distribution measured by the Coulter Multisizer II; and the particle sizes at an accumulation of 16% are defined as D16v for the volume and D16p for the number, the particle sizes at an accumulation of 50% are defined as D50v for the volume and D50p for the number, and the particle sizes at an accumulation of 84% are defined as D84v for the volume and D84p for the number. Here, D50v stands for the volume average particle diameter, and the volume average particle size distribution index (GSDv) is calculated as (D₈₄ᵥ/D₁₆ᵥ)^{1/2}, and the number average particle size distribution index (GSDp) is calculated as (D₈₄ₚ/D₁₆ₚ)^{1/2}.

(Differential Scanning Calorimetry (DSC))

The melting temperature of the releasing agent is measured using a differential scanning calorimeter (DSC-50; manufactured by Shimadzu Mfg. Works). The measurement is conducted in the temperature range of from room temperature to 150° C. with a temperature-increasing rate of 10° C. per minute. The melting temperature is determined by analyzing according to JIS (see, JIS K-7121).

(High Pressure Liquid Chromatography (HPLC))

Measuring conditions for high pressure liquid chromatography (HPLC) are as follows.

Analyzer: LC-08, manufactured by Japan Analytical Industry Co. Ltd.)

### Column: INERTSIL ODS3 (φ4.6×250 mm)

Detector: Refractive index detector, UV absorption

### Detector (254 nm)

Eluent: 0.1% phosphoric acid aqueous solution
Flow rate: 1.0 mL/min
Analysis sample: a sample prepared by dissolving 1 g of a toner in 10 mL of chloroform and filtering the solution to extract.
Retention time The peak for ethylenediaminedisuccinic acid appears after 5 min.

(NMR)

In the NMR spectrometry, a ¹H-NMR device (JNM-AL400; manufactured by JEOL Ltd.) is used. Regarding measuring conditions, measurement is conducted at a measuring temperature of 25° C. using a 5-mm glass tube and a 3% by weight heavy water solution. As an analysis sample, a sample prepared by removing a carrier from the developer, dissolving the resulting toner in an organic solvent (chloroform), and removing the binder resin through filtration is used.

<Production of Toner>

(Preparation of Resin Particle Dispersion 1)

| | | |
|---|---|---|
| (Oil layer) | | |
| Styrene | 30 | parts by weight |
| (manufactured by Wako Pure Chemical | | |
| Industries, Ltd.) | | |
| n-Butyl acrylate | 10 | parts by weight |
| (manufactured by Wako Pure Chemical | | |
| Industries, Ltd.) | | |
| β-Carboethyl acrylate | 1.5 | parts by weight |
| (manufactured by Rhodia Nikka) | | |
| Acrylic acid | 0.3 | part by weight |
| Dodecanethiol | 0.2 | part by weight |
| (manufactured by Wako Pure Chemical | | |
| Industries, Ltd.) | | |
| (Aqueous layer 1) | | |
| Deionized water | 17.0 | parts by weight |
| Anionic surfactant | 0.4 | part by weight |
| (manufactured by Rhodia) | | |
| (Aqueous layer 2) | | |
| Deionized water | 40 | parts by weight |
| Anionic surfactant | 0.08 | part by weight |
| (manufactured by Rhodia) | | |
| Potassium persulfate | 0.30 | part by weight |
| (manufactured by Wako Pure Chemical | | |
| Industries, Ltd.) | | |
| Ammonium persulfate | 0.10 | part by weight |
| (manufactured by Wako Pure Chemical | | |
| Industries, Ltd.) | | |

The above-described oil layer components and the components of aqueous layer 1 are placed in a flask and mixed by stirring to prepare a monomer emulsion dispersion. Components of the above-described aqueous layer 2 are introduced into a reaction vessel, the atmosphere within the vessel is sufficiently replaced by nitrogen, and the mixture is heated in an oil bath under stirring till the temperature of the reaction system reaches 75° C. The monomer emulsion dispersion is dropwise gradually added into the reaction vessel over 3 hours to conduct emulsion polymerization. After completion of the dropwise addition, polymerization is continued at 75° C., and the polymerization is completed after 3 hours.

The thus-obtained resin particles are found to have a number average particle diameter D50P of 200 nm by measuring with a laser diffraction particle size distribution analyzer (LA-700; manufactured by Horiba, Ltd.). The resin is found to have a glass transition temperature of 51.5° C. by measuring with a differential scanning calorimeter (DSC-50; manufactured by Seiko Electronic Industrial Co., Ltd.) at a temperature-increasing rate of 10° C./min and have a weight-average molecular weight Mw of 30,000 (in terms of polystyrene). Thus, there is obtained an anionic resin particle dispersion 1 having a number-average particle diameter D50p of 200 nm, a solid component content of 42% by weight, a glass transition temperature of 51.5° C., and a Mw of 30,000.

(Preparation of Resin Particle Dispersion 2)

A resin particle dispersion 2 is obtained in the same manner as with the resin particle dispersion 1 except for using butadiene in place of n-butyl acrylate and using 34 parts by weight of styrene and 6 parts by weight of butadiene.

(Preparation of Colorant Dispersion 1)

| | |
|---|---|
| Yellow pigment | 45 parts by weight |
| (C.I. Pigment Yellow 74; manufactured | |
| by Clariant Ltd.) | |
| Ionic surfactant | 5 parts by weight |
| (Neogen RK; manufactured by Dai-ichi | |
| Kogyo Seiyaku Co., Ltd.) | |
| Deionized water | 200 parts by weight |

The above-described components are mixed to dissolve, followed by dispersing in a homogenizer (IKA ULTRATALUX) for 10 minutes to thereby obtain a colorant dispersion 1 having a volume-average particle diameter of 170 nm.

(Preparation of Colorant Dispersion 2)

A colorant dispersion 2 is obtained in the same manner as with the colorant dispersion 1 except for using C.I. Pigment Yellow 180 (manufactured by Hoechst) in place of C.I. Pigment Yellow 74.

(Preparation of Inorganic Particle Dispersion (Preparatory Aggregation Product of Colloidal Silica A (ST-O)/Colloidal Silica B (ST-OL))

As colloidal silica A, ST-OL (manufactured by Nissan Chemical Industries, Ltd.) of 40 nm in volume-average particle diameter (ST-100) is used and, as colloidal silica B, colloidal silica ST-OS of 8 nm in volume-average particle diameter and ST-OS of 20 nm in volume-average particle diameter are used. 2 Parts by weight of colloidal silica A and 4 parts by weight of colloidal silica B are properly mixed, 15 parts by weight of a 0.025 mol/L nitric acid HNO₃ solution is added thereto, and 0.3 part by weight of polyaluminum chloride is added thereto, followed by allowing to stand for 20 minutes at ordinary temperature. The thus-aggregated product is used as such.

(Preparation of Releasing Agent Dispersion 1)

| | |
|---|---|
| Paraffin wax FNP0085 (melting temperature: | 45 parts by weight |
| 86° C.; manufactured by Nippon Seiro Co., Ltd.) | |
| Cationic surfactant (Neogen RK; manufactured | 5 parts by weight |
| by Dai-ichi Kogyo Seiyaku Co., Ltd.) | |
| Deionized water | 200 parts by weight |

The above-described components are heated to 90° C., sufficiently dispersed in a homogenizer of ULTRATALUX T50 manufactured by IKA, and then subjected to dispersing treatment in a pressure ejection type GAULIN homogenizer to thereby obtain a releasing agent dispersion 1 having a volume-average particle diameter of 200 nm and a solid component content of 24.3% by weight.

(Preparation of Releasing Agent Dispersion 2)

| | |
|---|---|
| Paraffin wax FNP0100 (melting temperature: | 45 parts by weight |
| 100° C.; manufactured by Nippon Seiro Co., Ltd.) | |
| Cationic surfactant (Neogen RK; manufactured | 5 parts by weight |
| by Dai-ichi Kogyo Seiyaku Co., Ltd.) | |
| Deionized water | 200 parts by weight |

The above-described components are heated to 105° C., sufficiently dispersed in a homogenizer of ULTRATALUX T50 manufactured by IKA, and then subjected to dispersing treatment in a pressure ejection type GAULIN homogenizer to thereby obtain a releasing agent dispersion 2 having a volume-average particle diameter of 200 nm and a solid component content of 24.3% by weight.

(Preparation of Releasing Agent Dispersion 3)

| | |
|---|---|
| Paraffin wax SP0160 (melting temperature: | 45 parts by weight |
| 71° C.; manufactured by Nippon Seiro Co., Ltd.) | |
| Cationic surfactant (Neogen RK; manufactured | 5 parts by weight |
| by Dai-ichi Kogyo Seiyaku Co., Ltd.) | |
| Deionized water | 200 parts by weight |

The above-described components are heated to 75° C., sufficiently dispersed in a homogenizer of ULTRATALUX T50 manufactured by IKA, and then subjected to dispersing treatment in a pressure ejection type GAULIN homogenizer to thereby obtain a releasing agent dispersion 3 having a volume-average particle diameter of 200 nm and a solid component content of 24.3% by weight.

(Preparation of Releasing Agent Dispersion 4)

| | |
|---|---|
| Microcrystalline wax HiMic 1090 (melting | 45 parts by weight |
| temperature: 88° C.; manufactured | |
| by Nippon Seiro Co., Ltd.) | |
| Cationic surfactant (Neogen RK; manufactured | 5 parts by weight |
| by Dai-ichi Kogyo Seiyaku Co., Ltd.) | |
| Deionized water | 200 parts by weight |

The above-described components are heated to 93° C., sufficiently dispersed in a homogenizer of ULTRATALUX T50 manufactured by IKA, and then subjected to dispersing treatment in a pressure ejection type GAULIN homogenizer to thereby obtain a releasing agent dispersion 4 having a volume-average particle diameter of 200 nm and a solid component content of 24.3% by weight.

(Preparation of Releasing Agent Dispersion 5)

| | |
|---|---|
| Fischer-Tropsch wax FT100 (melting | 45 parts by weight |
| temperature: 98° C.; manufactured | |
| by NOF Corporation) | |
| Cationic surfactant (Neogen RK; manufactured | 5 parts by weight |
| by Dai-ichi Kogyo Seiyaku Co., Ltd.) | |
| Deionized water | 200 parts by weight |

The above-described components are heated to 87° C., sufficiently dispersed in a homogenizer of ULTRATALUX T50 manufactured by IKA, and then subjected to dispersing treatment in a pressure ejection type GAULIN homogenizer to thereby obtain a releasing agent dispersion 5 having a volume-average particle diameter of 200 nm and a solid component content of 24.3% by weight.

(Preparation of Releasing Agent Dispersion 6)

| | |
|---|---|
| Ester wax WEP5 (melting temperature: 82° C.; | 45 parts by weight |
| manufactured by NOF Corporation) | |
| Cationic surfactant (Neogen RK; manufactured | 5 parts by weight |
| by Dai-ichi Kogyo Seiyaku Co., Ltd.) | |
| Deionized water | 200 parts by weight |

The above-described components are heated to 87° C., sufficiently dispersed in a homogenizer of ULTRATALUX T50 manufactured by IKA, and then subjected to dispersing treatment in a pressure ejection type GAULIN homogenizer to thereby obtain a releasing agent dispersion 6 having a volume-average particle diameter of 200 nm and a solid component content of 24.3% by weight.

(Preparation of Releasing Agent Dispersion 7)

| | |
|---|---|
| Paraffin wax FNP0105 (melting temperature: | 45 parts by weight |
| 103° C.; manufactured by | |
| Nippon Seiro Co., Ltd.) | |
| Cationic surfactant (Neogen RK; manufactured | 5 parts by weight |
| by Dai-ichi Kogyo Seiyaku Co., Ltd.) | |
| Deionized water | 200 parts by weight |

The above-described components are heated to 107° C., sufficiently dispersed in a homogenizer of ULTRATALUX T50 manufactured by IKA, and then subjected to dispersing treatment in a pressure ejection type GAULIN homogenizer to thereby obtain a releasing agent dispersion 7 having a volume-average particle diameter of 200 nm and a solid component content of 24.3% by weight.

(Preparation of Releasing Agent Dispersion 8)

| | |
|---|---|
| Paraffin wax HNP11 (melting temperature: | 45 parts by weight |
| 68° C.; manufactured by | |
| Nippon Seiro Co., Ltd.) | |
| Cationic surfactant (Neogen RK; manufactured | 5 parts by weight |
| by Dai-ichi Kogyo Seiyaku Co., Ltd.) | |
| Deionized water | 200 parts by weight |

The above-described components are heated to 75° C., sufficiently dispersed in a homogenizer of ULTRATALUX TSO manufactured by IKA, and then subjected to dispersing treatment in a pressure ejection type GAULIN homogenizer to thereby obtain a releasing agent dispersion 8 having a volume-average particle diameter of 200 nm and a solid component content of 24.3% by weight.

(Preparation of Releasing Agent Dispersion 9)

| | |
|---|---|
| Carnauba wax (melting temperature: | 45 parts by weight |
| 85° C.; manufactured | |
| by Toakasei Co., Ltd.) | |
| Cationic surfactant (Neogen RK; manufactured | 5 parts by weight |
| by Dai-ichi Kogyo Seiyaku Co., Ltd.) | |
| Deionized water | 200 parts by weight |

The above-described components are heated to 75° C., sufficiently dispersed in a homogenizer of ULTRATALUX TSO manufactured by IKA, and then subjected to dispersing treatment in a pressure ejection type GAULIN homogenizer to thereby obtain a releasing agent dispersion 9 having a volume-average particle diameter of 200 nm and a solid component content of 24.3% by weight.

(Preparation of Ethylenediaminedisuccinic Acid Dispersion)

| | |
|---|---|
| Trisodium ethylenediamine-Disuccinate | 20 parts by weight |
| (EDDS; manufactured by Chelest Corporation) | |
| Deionized water | 60 parts by weight |

The above-described components are mixed under stirring to obtain an ethylenediaminedisuccinic acid dispersion containing 10.2% by weight of solids.

### Example 1

| | |
|---|---|
| Resin particle dispersion 1 | 80 parts by weight |
| Colorant particle dispersion 1 | 18 parts by weight |
| Inorganic particle dispersion | 30 parts by weight |
| Releasing agent particle | 18 parts by weight |
| Dispersion 1 | |

Deionized water is added to the above-described components so that the solid component content becomes 16% by weight, and the resulting mixture is sufficiently mixed and dispersed by means of a homogenizer ULTRATALUX T50 in a round stainless steel-made flask. Subsequently, 0.36 part by weight of polyaluminum chloride is added thereto, followed by continuing dispersing operation in the ULTRATALUX. Then, the content in the flask is heated up to 47° C. by rotating the flask in a heating oil bath and, after maintaining at 47° C. for 60 minutes, 46 parts of the resin particle dispersion 1 is gradually added thereto. Thereafter, 10 parts by weight of the ethylenediaminedisuccinic acid dispersion is added thereto and, after tightly closing the stainless steel-made flask, the pH of the system is adjusted to 6.0 with a 0.55 mol/L sodium hydroxide aqueous solution, followed by heating up to 96° C. using magnetic force sealing while continuing stirring and maintaining the condition for 3.5 hours.

After completion of the reaction, the reaction mixture is cooled, filtered, washed sufficiently with deionized water, and subjected to solid-liquid separation by Nutsche suction filtration. The resulting product is re-dispersed in 3 L of a 40° C. deionized water, and stirred for 15 minutes at 300 rpm to wash. This washing procedure is repeated 5 times and, at a stage where the pH of the filtrate becomes 7.01, the electric conductivity becomes 9.7 μS, and the surface tension becomes 71.2 Nm, the product is subjected to solid-liquid separation by Nutsche suction filtration using No5A filter paper, followed by vacuum drying for 12 hours to obtain toner particles 1.

Measurement of the toner particles 1 reveals that the toner particles 1 have a volume average diameter of 6.1 μm, a volume average particle size distribution index GSDv of 1.26, a number average particle size distribution index GSDp of 1.25, and a ratio of the number average particle size distribution index GSDp to the volume average particle size distribution index GSDv (GSDp/GSDv) of 0.99. Also, the toner shape factor SF1 is found to be 134. Further, HPLC and NMR confirm that the toner contains ethylenediaminedisuccinic acid. The peak temperature of the releasing agent is found to be 86° C. by measurement using a differential scanning calorimeter (DSC-50; manufactured by Shimadzu Mfg. Works) at a temperature-increasing rate of 10° C./min.

Further, to 50 parts by weight of the thus-prepared toner particles 1 is added 1.0 part by weight of hydrophobic silica (TS720; manufactured by Cabot Corporation) and 2.0 parts by weight of hydrophobic silica (X24; manufactured by Shin-Etsu Chemical Co., Ltd.), and the resulting mixture is mixed in a sample mill. Then, the resulting toner is weighed so that the toner content becomes 5% using a ferrite carrier of 50 μm in volume average particle diameter coated with styrene-methyl methacrylate resin (manufactured by Soken Chemical & Engineering Co., Ltd.) in a coating amount of 1%, and the mixture is stirred and mixed in a ball mill for 5 minutes to prepare a developer 1.

### Example 2

Toner particles 2 are obtained in the same manner as in Example 1 except for using 18 parts of the releasing agent dispersion 2 in place of the releasing agent dispersion 1.

Measurement of the toner particles 2 reveals that the toner particles 2 have a volume average diameter of 6.2 μm, a volume average particle size distribution index GSDv of 1.25, a number average particle size distribution index GSDp of 1.25, and a ratio of the number average particle size distribution index GSDp to the volume average particle size distribution index GSDv (GSDp/GSDv) of 1.0. Also, HPLC and NMR confirmthat the toner contains ethylenediaminedisuccinic acid. The peak temperature of the releasing agent is found to be 100° C. by measurement using a differential scanning calorimeter (DSC-50; manufactured by Shimadzu Mfg. Works) at a temperature-increasing rate of 10° C./min. Further, a developer 2 is prepared in the same manner as in Example 1.

### Example 3

Toner particles 3 are obtained in the same manner as in Example 1 except for using 18 parts of the releasing agent dispersion 3 in place of the releasing agent dispersion 1.

Measurement of the toner particles 3 reveals that the toner particles 3 have a volume average diameter of 6.2 μm, a volume average particle size distribution index GSDv of 1.25, a number average particle size distribution index GSDp of 1.25, and a ratio of the number average particle size distribution index GSDp to the volume average particle size distribution index GSDv (GSDp/GSDv) of 1.00. Also, HPLC and NMR confirm that the toner contains ethylenediaminedisuccinic acid. The peak temperature of the releasing agent is found to be 71° C. by measurement using a differential scanning calorimeter (DSC-50; manufactured by Shimadzu Mfg. Works) at a temperature-increasing rate of 10° C./min. Further, a developer 3 is prepared in the same manner as in Example 1.

### Example 4

Toner particles 4 are obtained in the same manner as in Example 1 except for using 18 parts of the releasing agent dispersion 4 in place of the releasing agent dispersion 1.

Measurement of the toner particles 4 reveals that the toner particles 4 have a volume average diameter of 6.2 μm, a volume average particle size distribution index GSDv of 1.25, a number average particle size distribution index GSDp of 1.25, and a ratio of the number average particle size distribution index GSDp to the volume average particle size distribution index GSDv (GSDp/GSDv) of 1.00. Also, HPLC and NMR confirm that the toner contains ethylenediaminedisuccinic acid. The peak temperature of the releasing agent is found to be 88° C. by measurement using a differential scanning calorimeter (DSC-50; manufactured by Shimadzu Mfg. Works) at a temperature-increasing rate of 10° C./min. Further, a developer 4 is prepared in the same manner as in Example 1.

### Example 5

Toner particles 5 are obtained in the same manner as in Example 1 except for using 18 parts of the releasing agent dispersion 5 in place of the releasing agent dispersion 1.

Measurement of the toner particles 5 reveals that the toner particles 5 have a volume average diameter of 6.2 μm, a volume average particle size distribution index GSDv of 1.25, a number average particle size distribution index GSDp of 1.25, and a ratio of the number average particle size distribution index GSDp to the volume average particle size distribution index GSDv (GSDp/GSDv) of 1.00. Also, HPLC and NMR confirm that the toner contains ethylenediaminedisuccinic acid. The peak temperature of the releasing agent is found to be 98° C. by measurement using a differential scanning calorimeter (DSC-50; manufactured by Shimadzu Mfg. Works) at a temperature-increasing rate of 10° C./min. Further, a developer 5 is prepared in the same manner as in Example 1.

### Example 6

Toner particles 6 are obtained in the same manner as in Example 1 except for using 18 parts of the releasing agent dispersion 6 in place of the releasing agent dispersion 1.

Measurement of the toner particles 6 reveals that the toner particles 6 have a volume average diameter of 6.2 μm, a volume average particle size distribution index GSDV of 1.25, a number average particle size distribution index GSDp of 1.25, and a ratio of the number average particle size distribution index GSDp to the volume average particle size distribution index GSDv (GSDp/GSDv) of 1.00. Also, HPLC and NMR confirm that the toner contains ethylenediaminedisuccinic acid. The peak temperature of the releasing agent is found to be 82° C. by measurement using a differential scanning calorimeter (DSC-50; manufactured by Shimadzu Mfg. Works) at a temperature-increasing rate of 10° C./min. Further, a developer 6 is prepared in the same manner as in Example 1.

### Example 7

Toner particles 7 are obtained in the same manner as in Example 1 except for using 80 parts of the resin particle dispersion 2 in place of the resin particle dispersion 1.

Measurement of the toner particles 7 reveals that the toner particles 7 have a volume average diameter of 6.1 μm, a volume average particle size distribution index GSDv of 1.24, a number average particle size distribution index GSDp of 1.26, and a ratio of the number average particle size distribution index GSOp to the volume average particle size distribution index GSDv (GSDp/GSDv) of 1.02. Also, HPLC and NMR confirm that the toner contains ethylenediaminedisuccinic acid. The peak temperature of the releasing agent is found to be 86° C. by measurement using a differential scanning calorimeter (DSC-50; manufactured by Shimadzu Mfg. Works) at a temperature-increasing rate of 10° C./min. Further, a developer 7 is prepared in the same manner as in Example 1.

### Example 8

Toner particles 8 are obtained in the same manner as in Example 1 except for using 18 parts of the colorant dispersion 2 in place of the colorant dispersion 1.

Measurement of the toner particles 8 reveals that the toner particles 8 have a volume average diameter of 6.2 μm, a volume average particle size distribution index GSDv of 1.25, a number average particle size distribution index GSDp of 1.25, and a ratio of the number average particle size distribution index GSDp to the volume average particle size distribution index GSDv (GSDp/GSDv) of 1.00. Also, HPLC and NMR confirm that the toner contains ethylenediaminedisuccinic acid. The peak temperature of the releasing agent is found to be 86.5° C. by measurement using a differential scanning calorimeter (DSC-50; manufactured by Shimadzu Mfg. Works) at a temperature-increasing rate of 10° C./min. Further, a developer 8 is prepared in the same manner as in Example 1.

### Example 9

Toner particles 9 are obtained in the same manner as in Example 1 except for using 18 parts of the releasing agent dispersion 9 in place of the releasing agent dispersion 1.

Measurement of the toner particles 9 reveals that the toner particles 9 have a volume average diameter of 6.0 μm, a volume average particle size distribution index GSDv of 1.24, a number average particle size distribution index GSDp of 1.24, and a ratio of the number average particle size distribution index GSDp to the volume average particle size distribution index GSDv (GSDp/GSDv) of 1.00. Also, HPLC and NMR confirm that the toner contains ethylenediaminedisuccinic acid. The peak temperature of the releasing agent is found to be 84.5° C. by measurement using a differential scanning calorimeter (DSC-50; manufactured by Shimadzu Mfg. Works) at a temperature-increasing rate of 10° C./min. Further, a developer 9 is prepared in the same manner as in Example 1.

### Example 10

A developer 10 is prepared in the same manner as in Example 1 except for using a ferrite carrier coated with a styrene-t-butyl methacrylate resin (copolymerization ratio: 90:10; Mw: 86,000) in place of the ferrite carrier coated with the styrene-methyl methacrylate.

### Comparative Example 1

Toner particles 11 are obtained in the same manner as in Example 1 except for not adding the ethylenediaminedisuccinic acid dispersion upon production of the toner.

Measurement of the toner particles 11 reveals that the toner particles 11 have a volume average diameter of 6.2 μm, a volume average particle size distribution index GSDv of 1.25, a number average particle size distribution index GSDp of 1.25, and a ratio of the number average particle size distribution index GSDp to the volume average particle size distribution index GSDv (GSDp/GSDv) of 1.00. The peak temperature of the releasing agent is found to be 86° C. by measurement using a differential scanning calorimeter (DSC-50; manufactured by Shimadzu Mfg. Works) at a temperature-increasing rate of 10° C./min. Further, a developer 11 is prepared in the same manner as in Example 1.

### Comparative Example 2

Toner particles 12 are obtained in the same manner as in Example 1 except for using 18 parts of the releasing agent dispersion 7 in place of the releasing agent dispersion 1.

Measurement of the toner particles 12 reveals that the toner particles 12 have a volume average diameter of 6.2 μm, a volume average particle size distribution index GSDv of 1.25, a number average particle size distribution index GSDp of 1.25, and a ratio of the number average particle size distribution index GSDp to the volume average particle size distribution index GSDv (GSDp/GSDv) of 1.00. Also, HPLC and NMR confirm that the toner contains ethylenediaminedisuccinic acid. The peak temperature of the releasing agent is found to be 86° C. by measurement using a differential scanning calorimeter (DSC-50; manufactured by Shimadzu Mfg. Works) at a temperature-increasing rate of 10° C./min. Further, a developer 12 is prepared in the same manner as in Example 1.

### Comparative Example 3

Toner particles 13 are obtained in the same manner as in Example 1 except for using 18 parts of the releasing agent dispersion 8 in place of the releasing agent dispersion 1.

Measurement of the toner particles 13 reveals that the toner particles 13 have a volume average diameter of 6.2 μm, a volume average particle size distribution index GSDv of 1.25, a number average particle size distribution index GSDp of 1.25, and a ratio of the number average particle size distribution index GSDp to the volume average particle size distribution index GSDv (GSDp/GSDv) of 1.00. Also, HPLC and NMR confirm that the toner contains ethylenediaminedisuccinic acid. The peak temperature of the releasing agent is found to be 86° C. by measurement using a differential scanning calorimeter (DSC-50; manufactured by Shimadzu Mfg. Works) at a temperature-increasing rate of 10° C./min. Further, a developer 13 is prepared in the same manner as in Example 1.

<Evaluation of Toner>

Image formation is conducted by loading a developer in a modified machine of DocuCenterColor 400 (manufactured by Fuji Xerox Co., Ltd.) while adjusting so that a 10 cm×10 cm solid image-bearing image having a toner amount of 13.0 g/m² is formed on paper of MILLERCOATPRATINA paper manufactured by Fuji Xerox Co., Ltd. (basis weight: 104.7 g/m²). Then, the resulting images are fixed at a fixing speed of 180 mm/sec and a fixing temperature of 170° C. with a nip width of 6.5 mm using an external fixing device (the surface of the fixing roll being coated with PFA (tetrafluoroethylene/perfluoroalkyl vinyl ether copolymer; oil-less model). As the developer, the above-described developers 1 to 13 are used.

(Image Gloss Degree and Gloss Unevenness)

Measurement on the image gloss degree is conducted at 9 (x) points of each of the solid image areas according to JIS Z 8741 using a Gloss Meter GM-26D (manufactured by Murakami Color Research Laboratory) at an incidental angle of 75°. The gloss unevenness is evaluated based on the gloss degree of the surface of each fixed image determined by means of the Gloss Meter and the standard deviation thereof. A gloss degree of 60% or more is evaluated as acceptable, with a higher value being better. A gloss unevenness of 5 or less is evaluated as acceptable, with a smaller value being better. The results are shown in Table 1.

TABLE 1

| | | | | | Ethylene- | | | Melting | Evaluation | |
|---|---|---|---|---|---|---|---|---|---|---|
| | | | | | diamine | | | Temperature | | Gloss |
| | | | Color- | | Succinic | | | of Wax | Gloss | Uneven- |
| | Toner | Resin | ant | Carrier | Acid | Wax Kind | Wax Kind | [° C.] | Degree | ness |
| Example 1 | Toner 1 | St/n-BAA | PY74 | St/MMA resin-coated | Yes | Hydrocarbon | Paraffin | 86 | 82% | 1 |
| Example 2 | Toner 2 | St/n-BAA | PY74 | St/MMA resin-coated | Yes | Hydrocarbon | Paraffin | 100 | 63% | 4 |
| Example 3 | Toner 3 | St/n-BAA | PY74 | St/MMA resin-coated | Yes | Hydrocarbon | Paraffin | 71 | 72% | 5 |
| Example 4 | Toner 4 | St/n-BAA | PY74 | St/MMA resin-coated | Yes | Hydrocarbon | Microcrystal- | 88 | 80% | 3 |
| | | | | | | | line | | | |
| Example 5 | Toner 5 | St/n-BAA | PY74 | St/MMA resin-coated | Yes | Hydrocarbon | Fischer- | 98 | 81% | 3 |
| | | | | | | | Tropsch | | | |
| Example 6 | Toner 6 | St/n-BAA | PY74 | St/MMA resin-coated | Yes | Ester | Ester | 82 | 78% | 5 |
| Example 7 | Toner 7 | St/BD | PY74 | St/MMA resin-coated | Yes | Hydrocarbon | Paraffin | 86 | 77% | 3 |
| Example 8 | Toner 8 | St/n-BAA | PY180 | St/MMA resin-coated | Yes | Hydrocarbon | Paraffin | 86 | 79% | 2 |
| Example 9 | Toner 9 | St/n-BAA | PY74 | St/MMA resin-coated | Yes | Plant type | Carnauba | 85 | 80% | 4 |
| Example 10 | Toner 10 | St/n-BAA | PY74 | St/t-BMA resin-coated | Yes | Hydrocarbon | Paraffin | 86 | 80% | 3 |
| Comparative | Toner 11 | St/n-BAA | PY74 | St/MMA resin-coated | No | Hydrocarbon | paraffin | 86 | 62% | 7 |
| Example 1 | | | | | | | | | | |
| Comparative | Toner 12 | St/n-BAA | PY74 | St/MMA resin-coated | Yes | Hydrocarbon | Paraffin | 103 | 55% | 9 |
| Example 2 | | | | | | | | | | |
| Comparative | Toner 13 | St/n-BAA | PY74 | St/MMA resin-coated | Yes | Hydrocarbon | Paraffin | 68 | 65% | 11 |
| Example 3 | | | | | | | | | | |

St: styrene;
MMA: methyl methacrylate;
n-BAA: n-butyl acrylate;
t-BMA: t-butyl methacrylate;
BD: butadiene

As is described above, the toners of Examples 1 to 10 provide high-gloss images with suppressing occurrence of gloss unevenness. On the other hand, the toner of Comparative Example 1 provides a fixed image insufficient with respect to gloss unevenness. Also, with the toner of Comparative Example 2, the releasing agent is scarcely molten due to its high melting temperature, and hence releasing failure occurs, with gloss unevenness being confirmed. Further, with the toner of Comparative Example 3, the releasing agent adheres to the fixing roll due to its low melting temperature, thus gloss unevenness being confirmed.

What is claimed is:

1. An electrostatic-image-developing toner comprising:
a binder resin;
a colorant;
a releasing agent having a melting temperature of from about 70° C. to about 100° C.; and
an ethylenediaminedisuccinic acid.

2. The electrostatic-image-developing toner according to claim 1, wherein
the ethylenediaminedisuccinic acid is contained in an amount of from about 0.001% by weight to about 1.5% by weight based on a total weight of the toner.

3. The electrostatic-image-developing toner according to claim 1, wherein
the releasing agent is a hydrocarbon-typed wax.

4. The electrostatic-image-developing toner according to claim 3, wherein
the hydrocarbon-typed wax is a paraffin-typed wax.

5. The electrostatic-image-developing toner according to claim 1, wherein
the binder resin is a resin containing a copolymer of a styrene and an alkyl acrylate.

6. The electrostatic-image-developing toner according to claim 1, wherein
the colorant is Pigment Yellow 74.

7. The electrostatic-image-developing toner according to claim 1, wherein
the colorant is contained in an amount of from about 1 part by weight to about 20 parts by weight per 100 parts by weight of the resin.

8. The electrostatic-image-developing toner according to claim 1, which has on a surface thereof at least one kind of metal oxide particle.

9. The electrostatic-image-developing toner according to claim 8, wherein
the metal oxide particle has a volume-average particle diameter of from about 1 nm to about 40 nm as a primary particle diameter.

10. The electrostatic-image-developing toner according to claim 1, which has a shape factor SF1 of from about 125 to about 140.

11. The electrostatic-image-developing toner according to claim 1, which has a volume-average particle size distribution index GSDv of about 1.30 or less.

12. The electrostatic-image-developing toner according to claim 1, which has a surface area of from about 0.5 m²/g to about 10 m²/g by BET method.

13. A process for producing the electrostatic-image-developing toner described in claim 1, comprising:
mixing a resin particle dispersion containing the resin particle dispersed therein, a colorant dispersion containing the colorant dispersed therein, and a releasing agent dispersion containing the releasing agent having a melting temperature of from 70° C. to 100° C. dispersed therein to form an aggregated particle;
adding ethylenediaminedisuccinic acid to an aggregation system;
adjusting pH in the aggregation system to stop growth of aggregation of the aggregated particle; and
heating the aggregated particle up to a temperature equal to, or higher than, a glass transition temperature of the resin particle to fuse the aggregated particle.

14. The process according to claim 13, wherein
the aggregated particle has a core-shell structure in which a shell layer is formed in a surface of the aggregated particle.

15. An electrostatic image developer comprising:
the toner described in claim 1; and
a carrier.

16. The electrostatic image developer according to claim 15, wherein
the carrier comprises:
a core material; and
a resin-coating layer on a surface of the core material,
the resin-coating layer being prepared by coating the core material with a coating resin, which contains a copolymer of a styrene and a methyl methacrylate.

17. The electrostatic image developer according to claim 16, wherein
a coating amount of the coating resin is in a range of from about 0.1 part by weight to about 10 parts by weight per 100 parts by weight of the core material.

18. An image-forming apparatus comprising:
an image-holding member;
a latent-image-forming unit that forms a latent image on a surface of the image-holding member;
a developing unit that develops the latent image by using a developer to form a toner image; and
a transfer unit that transfers the toner image onto a transfer-receiving material,
wherein
the developer is the electrostatic image developer described in claim 15.
